(19) United States
(12) Patent Application Publication
(10) Pub. No.: US 2007/0129489 A1
(43) Pub. Date: Jun. 7, 2007

(54) Thermoplastic composition and articles having high impact strength and good appearance

(75) Inventors: Xiangyang Li, Seven Fields, PA (US); James Y. J. Chung, Wexford, PA (US); James P. Mason, Carnegie, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 11/291,571

(22) Filed: Dec. 1, 2005

(51) Int. Cl. C08L 51/04; C08L 67/00; C08L 69/00; B32B 27/00

(52) U.S. Cl. 525/67; 525/439

(57) ABSTRACT

A thermoplastic molding composition suitable for making molded articles having high impact strength and good surface appearance is disclosed. The composition contains a blend of (co)polycarbonate, (co)polyester, and a grafted rubber. The structure of the grafted rubber includes a substrate and a grafted phase, and the substrate includes a core of crosslinked polymerized vinyl monomers and a shell, enveloping the core, the shell contains at least one crosslinked, polymerized acrylate which has a glass transition temperature less than 0° C.

### FIELD OF THE INVENTION

The invention concerns a thermoplastic molding composition and more particularly a composition containing (co)polycarbonate, (co)polyester and an impact strength modifier.

### TECHNICAL BACKGROUND OF THE INVENTION

Injection molded articles made of a composition that contains polycarbonate and thermoplastic polyester (polyalkylene terephthalate) are often toughened by including impact strength modifiers such as acrylonitrile-butadiene-styrene copolymer (ABS) or methyl methacrylate-butadiene-styrene copolymer (MBS). Exposure of such impact modifiers to visible and to ultraviolet light brings about their deterioration and as a consequence degradation of the mechanical/physical properties and discoloration of the composition in which they are included. While impact modifiers that are based on acrylate rubber are known to be more resistant to such effects, it has long been observed that articles molded from these compositions often exhibit pronounced cosmetic defects near the gate area, referred to as tiger stripes. These surface defects that appear as alternating shiny bands perpendicular to the flow direction, are also referred to as “flow marks”, or “ice lines”.

U.S. Pat. No. 4,148,842 disclosed an impact resistant blend containing polycarbonate resin and an interpolymer modifier comprising a crosslinked (meth)acrylate, crosslinked styrene-acrylonitrile (SAN) and un-crosslinked SAN components. Compositions containing polycarbonate and acrylate-styrene-acrylonitrile (ASA) graft polymer and the methods for their preparation were disclosed in U.S. Pat. Nos. 3,655,824 and 3,891,719. JP 50154349 disclosed flame retardant compositions containing PC and ASA. Also relevant is WO 02/36688 that disclosed compositions having improved impact strength and reduced gate blush containing polycarbonate (PC), ASA and high molecular weight acrylic copolymer as processing aid.

U.S. Pat. No. 6,476,126 disclosed a weatherable molding composition having improved surface appearance containing polycarbonate and a grafted rubber that contains a core/shell structure. In particular the grafted rubber entailed a crosslinked rubber substrate which contains a crosslinked core and a shell containing at least one polymerized acrylate, to which a rigid phase is grafted. The compositions thus disclosed contain 10 to 50 percent by weight of a grafted rubber, the structure of which is presently relevant. The disclosed improvement in surface aesthetics was achieved at a sacrifice of impact strength.

U.S. Pat. Nos. 5,104,934 and 5,082,897 are noted for disclosing thermoplastic molding compositions containing polycarbonate, polyesters and ABS or ASA. These compositions are said to exhibit enhanced moldability, heat resistance and thick section impact resistance.

### SUMMARY OF THE INVENTION

A thermoplastic molding composition suitable for making molded articles having high impact strength and good surface appearance is disclosed. The composition contains a blend of (co)polycarbonate, (co)polyester, and a grafted rubber. The structure of the grafted rubber includes a substrate and a grafted phase, and the substrate includes a core of crosslinked polymerized vinyl monomers and a shell containing at least one crosslinked, polymerized acrylate which has a glass transition temperature less than 0° C. enveloping the core.

### DETAILED DESCRIPTION OF THE INVENTION

The inventive thermoplastic composition is suitable for the preparation of molded articles characterized by high gloss, high impact strength and the absence of tiger stripes. The composition comprises
(A) 9.9 to 99.8, preferably 50 to 85, wt. % of (co)polycarbonate resin,
(B) 0.1 to 90, preferably 5 to 60 wt. % of (co)polyester and
(C) 0.1 to 30 preferably 2 to 15 wt. % of grafted rubber, the percentages being relative to the total weight of A, B and C.

In a preferred embodiment the composition contains at least one colorant. Suitable as component (A) are homopolycarbonates, copolycarbonates and polyestercarbonates (the term polycarbonate as used herein refers to any of these resins, each characterized in that its molecular structure includes at least one carbonate linkage)and mixtures thereof.

Polycarbonates are known and their structure and methods of preparation have been disclosed, for example, in U.S. Pat. Nos. 3,030,331; 3,169,121; 3,395,119; 3,729,447; 4,255,556; 4,260,731; 4,369,303, 4,714,746 and 6,306,507 all of which are incorporated by reference herein. The polycarbonates generally have a weight average molecular weight of 10,000 to 200,000, preferably 20,000 to 80,000 and their melt flow rate, per ASTM D-1238 at 300° C., under 1.2 Kg load, is about 1 to about 65 g/10 min., preferably about 2 to 35 g/10 min. They may be prepared, for example, by the known diphasic interface process from a carbonic acid derivative such as phosgene and dihydroxy compounds by polycondensation (see German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964, all incorporated herein by reference).

In the present context, dihydroxy compounds suitable for the preparation of the polycarbonates of the invention conform to the structural formula (1) or (2). 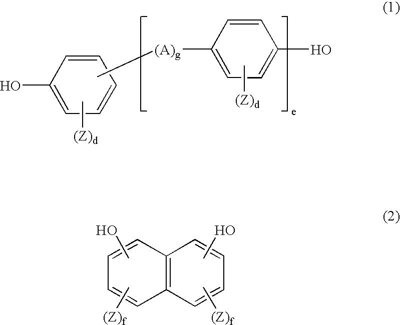
wherein
A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical conforming to 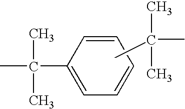
e and g both denote the number 0 to 1;
Z denotes F, Cl, Br or C₁-C₄-alkyl and if several Z radicals are substituents in one aryl radical, they may be identical or different from one another;
d denotes an integer of from 0 to 4; and
f denotes an integer of from 0 to 3.

Among the dihydroxy compounds useful in the practice of the invention are hydroquinone, resorcinol, bis-(hydroxyphenyl)-alkanes, bis-(hydroxyphenyl)-ethers, bis-(hydroxyphenyl)-ketones, bis-(hydroxy-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,105,004; 5,126,428; 5,109,076; 5,104,723; 5,086,157; 3,028,356; 2,999,835; 3,148,172; 2,991,273; 3,271,367; and 2,999,846, all incorporated herein by reference.

Further examples of suitable bisphenols are 2,2-bis-(4-hydroxy-phenyl)-propane (bisphenol A), 2,4-bis-(4-hydroxyphenyl)-2-methyl-butane, 1,1-bis-(4-hydroxyphenyl)-cyclohexane, α,α′-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxy-phenyl)-3,3,5-trimethylcyclohexane.

The most preferred bisphenol is 2,2-bis-(4-hydroxyphenyl)-propane (bisphenol A).

The polycarbonates of the invention may entail in their structure units derived from one or more of the suitable bisphenols.

Among the resins suitable in the practice of the invention are polyestercarbonate based on resorcinol and bisphenol A (registry number 265997-77-1), phenolphthalein-based polycarbonate, copolycarbonates and terpoly-carbonates such as are described in U.S. Pat. Nos. 6,306,507, 3,036,036 and 4,210,741, all incorporated by reference herein.

The polycarbonates of the invention may also be branched by condensing therein small quantities, e.g., 0.05 to 2.0 mol % (relative to the bisphenols) of polyhydroxyl compounds.

Polycarbonates of this type have been described, for example, in German Offenlegungsschriften 1,570,533; 2,116,974 and 2,113,374; British Patents 885,442 and 1,079,821 and U.S. Pat. No. 3,544,514. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxyphenyl)-2-(2,4-dihydroxy-phenyl)-propane and 1,4-bis-(4,4′-dihydroxytriphenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in the incorporated herein by reference, U.S. Pat. Nos. 3,028,365; 2,999,846; 3,153,008; and 2,991,273.

The preferred process for the preparation of polycarbonates is the interfacial polycondensation process. Other methods of synthesis in forming the polycarbonates of the invention, such as disclosed in U.S. Pat. Nos. 3,912,688, incorporated herein by reference, may be used.

Suitable polycarbonate resins are available in commerce, for instance, Makrolon 2400, Makrolon 2458, Makrolon 2600, Makrolon 2800 and Makrolon 3100, all of which are bisphenol based homopolycarbonate resins differing in terms of their respective molecular weights and characterized in that their melt flow indices (MFR at 300° C., 1.2 Kg) per ASTM D-1238 are about 16.5 to 24, 13 to 16, 7.5 to 13.0 and 3.5 to 6.5 g/10 min., respectively. These are products of Bayer MaterialScience LLC of Pittsburgh, Pa. Suitable polyestercarbonate has a CAS number of 265997-77-1.

The term (co)polyester suitable as component (B), include homo-polyesters and co-polyesters resins, these are resins the molecular structure of which include at least one bond derived from a carboxylic acid, preferably excluding linkages derived from carbonic acid. These are known resins and may be prepared through condensation or ester interchange polymerization of the diol component with the diacid according to known methods. Examples are esters derived from the condensation of a cyclohexanedimethanol with an ethylene glycol with a terephthalic acid or with a combination of terephthalic acid and isophthalic acid. Also suitable are polyesters derived from the condensation of a cyclohexanedimethanol with an ethylene glycol with a 1,4-Cyclohexanedicarboxylic acid. Suitable resins include poly(alkylene dicarboxylates), especially poly(ethylene terephthalate) (PET), poly(1,4-butylene terephthalate) (PBT), poly(trimethylene terephthalate) (PTT), poly(ethylene naphthalate) (PEN), poly(butylenes naphthalate) (PBN), poly(cyclohexanedimethanol terephthalate) (PCT), poly(cyclohexanedimethanol-co-ethylene terephthalate) (PETG or PCTG), and poly(1,4-cyclohexanedimethyl-1,4-cyclohexanedicarboxylate) (PCCD).

U.S. Pat. Nos. 2,465,319, 3,953,394 and 3,047,539, all incorporated herein by reference, disclose suitable methods for preparing such resins. The suitable polyalkylene terephthalates are characterized by an intrinsic viscosity of at least 0.2 and preferably about at least 0.4 deciliter/gram as measured by the relative viscosity of an 8% solution in orthochlorophenol at about 25° C. The upper limit is not critical but it generally does not exceed about 2.5 deciliters/gram. Especially preferred polyalkylene terephthalates are those with an intrinsic viscosity in the range of 0.4 to 1.3 deciliter/gram.

The alkylene units of the polyalkylene terephthalates which are suitable for use in the present invention contain from 2 to 5, preferably 2 to 4 carbon atoms. Polybutylene terephthalate (prepared from 1,4-butanediol) and polyethylene terephthalate are the preferred polyalkylene tetraphthalates for use in the present invention. Other suitable polyalkylene terephthalates include polypropylene terephthalate, polyisobutylene terephthalate, polypentyl terephthalate, polyisopentyl terephthalate, and polyneopentyl terephthalate. The alkylene units may be straight chains or branched chains.

Component (C) denotes a grafted rubber comprising 30 to 80 percent, preferably 40 to 70 percent, relative to its weight, of a rubber substrate which contains
(C1) about 1 to 50%, relative to the weight of the substrate, of a core which contains at least one crosslinked vinyl polymer, and
(C2) about 50 to 99%, relative to the weight of the substrate of a shell containing at least one crosslinked acrylate (co)polymer having glass transition temperature that is lower than 0° C., preferably lower than −20° C., to which rubber substrate is grafted
(C3) 70 to 20 percent, preferably 60 to 30 percent, relative to the weight of the grafted rubber, of a rigid grafted phase.

In a preferred embodiment, the composition is characterized in that the particle size (weight average particle size) of the grafted rubber is about 0.05 to 5 microns, preferably 0.1 to 2 microns.

The substrate contains
1 to 50, preferably 3 to 40, percent relative to the weight of the substrate, of a core (C1) and
99 to 50, preferably 97 to 60, percent relative to the weight of the substrate of a shell (C2) where
(C1) denotes a crosslinked polymerized product at least one member selected from the group consisting of styrene, α-methyl styrene, ring-halogenated styrene, ring-alkylated styrene, methyl methacrylate, acrylonitrile and the copolymer of any of them with another and the copolymer of any of them with acrylate
   and where
(C2) denotes a shell enveloping the core and comprising crosslinked rubber having glass transition temperature below 0° C., preferably below −20° C. selected from the group consisting of C₁₋₁₈-alkyl acrylate, preferably C₂₋₈-alkyl acrylate, and copolymers of C₁₋₁₈-alkyl acrylate, preferably C₂₋₈-alkyl acrylate with aromatic acrylate
   said substrate being present in particulate form having a size (weight average particle size) of about 0.05 to 4, preferably 0.1 to 1 microns.

The grafted phase (C3) contains a copolymer of at least one monomer selected from a first group consisting of styrene, α-methyl styrene, ring-halogenated styrene and ring-alkylated styrene, such as p-methylstyrene and tert.butylstyrene with at least one monomer selected from a second group consisting of (meth)acrylonitrile, methylmethacrylate and maleic anhydride. The weight ratio between said monomer(s) of said first group to said monomer(s) of said second group of 90:10 to about 50:50. The grafted phase is preferably a styrene/acrylonitrile copolymer, a α-methyl styrene/acrylonitrile copolymer or a α-methyl styrene/styrene/acrylonitrile terpolymer. The copolymerization of styrene and/or α-methyl styrene with acrylonitrile may be carried out by radical polymerization, preferably, mass polymerization, solution polymerization, suspension polymerization or aqueous emulsion polymerization.

Component (C3) of the inventive composition, may be prepared by graft copolymerization of at least one of styrene, α-methyl styrene, ring halogenated styrene, ring-alkylated styrene, such as p-methylstyrene and tert-butylstyrene with at least one of (meth)acrylonitrile, methylmethacrylate and maleic anhydride in the presence of the crosslinked, elastomeric core-shell substrate. Since 100% grafting yield cannot be achieved in the graft copolymerization, the polymerization product from the graft copolymerization always contains a proportion of free, non-grafted copolymer.

The particle size according to the invention is the weight-average particle size as determined by an ultracentrifuge, such as in accordance with the method of W. Scholtan and H. Lange, Kolloid-Z. und Z.-Polymere 250 (1972), 782-796. The ultracentrifuge measurement gives the integral mass distribution of the particle diameters of a sample. From this, it is possible to determine that the percentage by weight of the particles have a diameter equal to or less than a certain size.

The grafted rubber (C) useful according to the invention may be prepared in the conventional manner by methods which are well known in the art. The core polymer (C1) which is crosslinked may be prepared by conventional emulsion techniques which are well known in the art. Crosslinking may be attained by the incorporation of small amounts, usually about 0.05 to 10%, preferably 0.1 to 5%, relative to the weight of the core, of any of the polyfunctional monomeric cross-linking agents, which are well known in the art. Examples include triallyl cyanurate, diallyl maleate and divinyl benzene.

The rubber shell (C2) which may optionally contain units derived from C₁₋₆-alkylmethacrylate is characterized in that its glass transition temperature is below 0° C., preferably below −20° C. The glass transition temperature of the acrylic acid ester polymer may be determined by the DSC method (K. H. Illers, Makromol. Chemie 127 (1969), page 1). Specific examples are n-butyl acrylate and 2-ethylhexyl acrylate. The acrylic acid esters may be employed as individual compounds or as mixtures with one another. In the preparation of the substrate, the acrylic acid esters (or the other monomers making up the shell) are polymerized in the presence of the previously prepared core polymer (C1).

In order to obtain crosslinking of the preferred acrylic polymers, the polymerization is preferably carried out in the presence of from 0.05 to 10% by weight, preferably from 0.1 to 5% by weight, based on the total monomers employed for the preparation of the grafting bases, of a copolymerizable, polyfunctional, preferably trifunctional, monomer which effects crosslinking and subsequent grafting. Suitable difunctional or polyfunctional crosslinking monomers are those which contain two or more, preferably three, ethylenic double bonds which are capable of copolymerization and are not conjugated in the 1,3-positions. Examples of suitable crosslinking monomers are divinylbenzene, diallyl maleate, diallyl fumarate and diallyl phthalate, and triallyl cyanurate and triallyl isocyanurate. Grafting agents may optionally be included, including unsaturated monomers having epoxy, hydroxy, carboxyl, and amino or acid anhydride groups, for example hydroxyalkyl (meth)acrylates.

The preparation of the grafted phase (C3) may be carried out in accordance with the following method. The rigid core (C1) is first prepared by polymerizing the vinyl monomer(s) to form a crosslinked core in aqueous emulsion by conventional methods at from 20 to 100° C., preferably from 50 to 90° C. The conventional emulsifiers, for example alkali metal salts of alkyl sulfonic acids or alkyl aryl sulfonic acids, alkyl sulfates, fatty alcohol sulfonates, salts of higher fatty acids of 10 to 30 carbon atoms, or resin soaps, may be used. The sodium salts of alkyl sulfonic acids or the sodium salts of fatty acids of from 10 to 18 carbon atoms are preferred. Advantageously, the emulsifier is used in an amount of from 0 to 5% by weight, especially from 0 to 2% by weight, based on the monomer(s) employed to prepare the core (C1). In general, water-to-monomer ratio of from 50:1 to 0.7:1 is used. The polymerization initiators used are in particular the conventional persulfates, e.g., potassium persulfate, but redox systems can also be employed. In general, the initiator is used in an amount of from 0.1 to 1% by weight, based on the monomer(s) employed in the preparation of the core (C1). Further polymerization additives which may be employed are the conventional buffers, to bring the pH to about 6 to 9, for example, sodium bicarbonate and sodium pyrophosphate, and from 0 to 3% by weight of a molecular weight regulator, for example, a mercaptan, terpinol, or dimeric alpha-methyl styrene.

The precise polymerization conditions, such as the nature, rate of addition, and amount of the emulsifier, initiator, and other additives, are selected, within the ranges referred to above so that the resulting latex of the crosslinked vinyl aromatic core polymer attains the indicated particle size.

The preparation of the crosslinked rubber shell (C2) in the presence of the rigid core (C1) to form the substrate according to the invention may be carried out by polymerizing the indicated monomers, for instance, acrylic acid ester or esters, and the polyfunctional crosslinking/-graft linking monomer, in aqueous emulsion by conventional methods at from 20 to 100° C., preferably from 50 to 80° C. The conventional emulsifiers, for example alkali metal salts of alkyl sulfonic acids or alkyl aryl sulfonic acids, alkyl sulfates, fatty alcohol sulfonates, salts of higher fatty acids of 10 to 30 carbon atoms, or resin soaps, may be used. The sodium salts of alkyl sulfonic acids or the sodium salts of fatty acids of from 10 to 18 carbon atoms are preferred. Advantageously, the emulsifier is used in an amount of from 0 to 5% by weight, especially from 0 to 2% by weight, based on the monomer(s) employed to prepare the crosslinked shell (C2). In general, water-to-monomer ratio of from 5:1 to 0.7:1 is used. The polymerization initiators used are in particular the conventional persulfates, e.g., potassium persulfate, but redox systems may also be employed. In general, the initiator is used in an amount of from 0.1 to 1% by weight, based on the monomer(s) employed in the preparation of the crosslinked shell (C2). Further polymerization additives which may be employed are the conventional buffers, to bring the pH to about 6 to 9, for example, sodium bicarbonate and sodium pyrophosphate, and from 0 to 3% by weight of a molecular weight regulator, for example, a mercaptan, terpinol, or dimeric alpha-methyl styrene.

The precise polymerization conditions, such as, the nature, rate of addition, and amount of the emulsifier, initiator, and other additives, are selected, within the ranges referred to above, so that the resulting latex of the substrate attains the particle size required in accordance with the present invention.

To prepare the rigid grafted phase (C3), a monomer system containing at least one monomer selected from a first group consisting of styrene, α-methyl styrene, ring-alkylated styrene, such as, p-methylstyrene and tert-butylstyrene with at least one monomer selected from a second group consisting of (meth)acrylonitrile, methylmethacrylate and maleic anhydride is polymerized in the presence of the crosslinked rubber. The weight ratio between the monomer of said first group to the monomer of said second group is 90:10 to about 50:50.

It is advantageous if this graft copolymerization of the grafted phase onto the crosslinked rubber substrate is carried out in aqueous emulsion according to known methods. The graft copolymerization may advantageously be carried out in the same system as the emulsion polymerization which is used to prepare the substrate, optionally with the further addition of emulsifier and initiator. The monomer system to be grafted onto the base may be added to the reaction mixture all at once, in several stages or, preferably, continuously during the polymerization. Since the grafting yield of the graft copolymerization is not 100%, it is necessary to employ a somewhat larger amount of the monomer mixture for the graft copolymerization than would correspond to the desired degree of grafting. The control of the grafting yield of the graft copolymerization, and hence the degree of grafting of the finished grafted rubber (C) is familiar to the art-skilled and is effected, inter alia, by the rate of addition of the monomers and by adding a molecular chain regulator (Chauvel and Daniel, ACS Polymer Preprints 15 (1974), 329 et seq.).

The mixing of the components for the preparation of the inventive composition may be carried out conventionally by method and using equipment which are well known in the art.

The composition may further contain one or more conventional functional additives such as fillers, other compatible plastics, antistatic agents, antioxidants, flame retardant agents, lubricants and UV stabilizers. Suitable fillers include talc, clay, nanoclay (The prefix “nano” as used herein refers to particle size of less than about 100 nanometers), silica, nanosilica as well as reinforcing agents such as glass fibers. Suitable UV absorbers include hydroxybenzophenones, hydroxybenzotriazoles, hydroxybenzotriazines, cyanoacrylates, oxanilides, and benzoxazinones as well as nano-sized inorganic materials such as titanium oxide, cerium oxide, and zinc oxide. Suitable stabilizers include carbodiimides, such as bis-(2,6-diisopropylphenyl) carbodiimide and polycarbodiimides; hindered amine light stabilizers; hindered phenols (such as Irganox 1076 (CAS number 2082-79-3), Irganox 1010 (CAS number 6683-19-8); phosphites (such as Irgafos 168, CAS number 31570-04-4; Sandostab P-EPQ, CAS number 119345-01-6; Ultranox 626, CAS number 26741-53-7; Ultranox 641, CAS number 161717-32-4; Doverphos S-9228, CAS number 154862-43-8), triphenyl phosphine, and phosphorous acid. Suitable hydrolytic stabilizers include epoxides such as Joncryl ADR-4368-F, Joncryl ADR-4368-S, Joncryl ADR-4368-L, cycloaliphatic epoxy resin ERL-4221 (CAS number 2386-87-0). Suitable flame retardants include phosphorus compounds such as tributyl phosphate, triphenyl phosphate, tricresyl phosphate, diphenylcresyl phosphate, diphenyloctyl phosphate, diphenyl-2-ethylcresyl phosphate, tri-(isopropylphenyl) phosphate, methylphosphonic acid dimethyl esters, methylphosphonic acid diphenyl esters, phenylphosphonic acid diethyl esters, triphenylphosphine oxide, tricresylphosphine oxide and halogenated compounds. Especially advantageous are compounds conforming to formula (V) 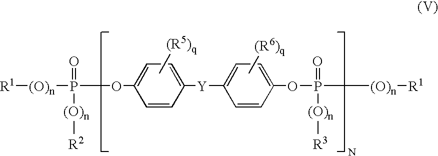
wherein
R¹, R², R³ and R⁴ independently one of the others denote C₁- to C₈-alkyl, or C₅- to C₆-cycloalkyl, C₆- to C₂₀-aryl or C₇- to C₁₂-aralkyl each optionally substituted by alkyl, preferably R¹, R², R³ and R⁴ independently one of the others denote C₁-C₄-alkyl,
n independently one of the others denotes 0 or 1, preferably 1.
N is 0.1 to 30, preferably 0.5 to 10, especially 0.7 to 5,
q independently one of the other denote 0, 1, 2, 3 or 4, preferably 0, 1 or 2, and R⁵ and R⁶ independently one of the others denote C₁-C₄-alkyl, preferably methyl, and Y represents C₁-C₇-alkylidene, C₁-C₇-alkylene, C₅-C₁₂-cycloalkylene, C₅-C₁₂-cycloalkylidene, —O—, —S—, —SO—, SO₂ or —CO—.

Especially preferred are compounds conforming to formula (V) that are derived from bisphenol A or methyl-substituted derivatives thereof.

Such stabilizer additives are known in the art and are disclosed in standard reference works such as “Plastics Additives Handbook”, 5^{th} edition, edited by H. Zweifel, Hanser Publishers incorporated herein by reference. The additives may be used in effective amounts, preferably of from 0.01 to a total of about 30% relative to the total weight of the resinous components A, B and C. The inventive molding composition is suitable for making useful articles by any of the thermoplastic processes, including injection molding, blow molding and extrusion.

The inventive thermoplastic composition may be molded into useful articles. It is particularly well suited for outdoor applications where high gloss, good aesthetics, and high impact resistance are required. Such applications include, but not limited to, automotive articles (e.g., grilles, mirror housings, door handles), as well as lawn and garden equipment (such as tractor hood), sporting goods, electronic equipment, business equipment, house-wares and packaging materials.

The examples which follow illustrate the invention. In the examples, parts and percentages are by weight, unless stated otherwise.

### EXAMPLES

Compositions within the scope of the invention were prepared and their properties determined. These were compared to similar compositions that differed only in terms of the chemistry and structure of the included grafted rubber.

The compositional components used in the course of the experiments described below were:
PC: Makrolon 2458 homopolycarbonate resin based on bisphenol-A, a product of Bayer MaterialScience LLC. Having a melt flow rate of about 20 g/10 min (at 300° C., 1.2 Kg load) determined in accordance with ASTM D 1238
PET: Polyethylene terephthalate having intrinsic viscosity of 0.94
GR1: denotes a grafted rubber which is outside the scope of the invention, Blendex 984 a product of Chemtura the structure of which entails butyl acrylate rubber and a grafted SAN phase, its rubber content is about 45 weight percent, the average particle size is about 0.4 micron. The structure includes no core corresponding to the inventive C1.
GR2: denotes a grafted rubber which is outside the scope of the invention, Royaltuf 960A a product of Chemtura the structure of which entails butyl acrylate rubber and a grafted SAN phase, its rubber content is about 60 weight percent, the average particle size is about 0.4 micron. The structure includes no core corresponding to the inventive C1.
GR3 denotes an SAN-grafted rubber within the scope of the invention, its rubber content is about 57 weight percent as determined by DSC, the average particle size is about 0.3 micron. The weight ratio of styrene to acrylonitrile of this rubber modifier (determined by infrared spectroscopy) is about 27 to 1, the glass transition temperature of its acrylate shell is −41° C. as determined by DSC (at heating rate of 20° C. per min.)

The compositions indicated as Examples 1-4 all contained 85 parts by weight (pbw) polycarbonate, 25 pbw PET and the indicated amount of the grafted rubber. In addition, each composition contained 0.7 pbw of a conventional UV absorber, 0.1 pbw of a conventional thermal stabilizer and 1 pbw colorants, having no criticality in the context of the invention. It was however noted that tiger stripes are more pronounced in compositions containing black colorants.

In the preparation of exemplified compositions, the components and additives were melt compounded in a twin screw extruder ZSK 30 at a temperature profile from 120 to 255° C. The pellets obtained were dried in a forced air convection oven at 120° C. for 4 to 6 hours. The Izod bars were injection molded (melt temperature 265 to 285° C., mold temperature about 75° C.).

The absence or presence of “tiger-stripes” was determined by inspection of 8×12×0.125″ plaques which were molded with a molding tool which had the tab gate on the edge of the long side of the mold. The melt temperature was about 285° C. and the mold temperature was about 75° C. The melt fill time was about 3 to 3.7 seconds.

The determination of Izod impact strength was carried out using specimens ⅛″ in thickness. Measurements were at 23° C., in accordance with ASTM D-256.

The results of the determinations are shown in the table below. The indicated grafted rubbers, their contents (pbw) and the properties of the compositions are described as follows:

TABLE

| | 1 | 2 | 3 | 4 |
|---|---|---|---|---|
| GR1 | 4 | — | — | — |
| GR2 | — | 4 | — | — |
| GR3 | — | — | 4 | 5 |
| Properties | | | | |
| Impact, Izod ft-lb/in | 2.5 | 3.6 | 14.6 | 14.9 |
| Appearance¹ | F | F | G | G |

¹F- denotes the appearance with severe tiger stripes; G denotes a molded part showing no tiger stripes.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic molding composition comprising
(A) 9.9 to 99.8% polycarbonate,
(B) 0.1 to 90% (co)polyester, and
(C) 0.1 to 30% grafted rubber
said % being relative to the weight of the composition,
where said grafted rubber includes a substrate in an amount of 30 to 80 percent and a rigid grafted phase in an amount 70 to 20 percent, said percents relative to the weight of said grafted rubber, said substrate including
(C1) 1 to 50%, relative to the weight of the substrate of core containing the crosslinked polymerization product of at least one vinyl monomer and
(C2) 50 to 99% relative to the weight of the substrate of a shell enveloping said core, that contains at least one crosslinked, polymerized acrylate which has a glass transition temperature less than 0° C.,
said rigid grafted phase (C3) including a copolymer of at least one monomer selected from a first group consisting of styrene, α-methyl styrene, ring-halogenated styrene and ring-alkylated styrene, and at least one monomer selected from a second group consisting of (meth)acrylonitrile, methylmethacrylate and maleic anhydride, at a weight ratio between said monomer(s) of said first group to the monomer(s) of said second of 90:10 to about 50:50.

2. The composition of claim 1 wherein said core includes the crosslinked polymerized product at. least one member selected from the group consisting of styrene, α-methyl styrene, ring-halogenated styrene, ring-alkylated styrene, methyl methacrylate, acrylonitrile and the copolymer of any of them with another and the copolymer of any of them with acrylate.

3. The composition of claim 1 wherein said lass transition temperature is lower than −20° C.

4. The composition of claim 1 wherein the substrate and grafted phase relate one to the other, by weight, as 40:70 to 60:30.

5. The composition of claim 1 wherein said grafted rubber is present in particulate form having a weight average particle size of about 0.05 to 5 microns.

6. The composition of claim 1 wherein said shell is polymerized butyl acrylate.

7. The composition of claim 1 wherein said grafted rubber (C) is present at an amount of 2 to 15%.

8. The composition of claim 1 wherein said (co)polyester (B) is at least one member selected from the group consisting of PET, PBT, PCT, PETG, PCTG, PCCD, PPT, PEN and PBN.

9. The composition of claim 1 wherein said polycarbonate contains structural units derived from bisphenol-A.

10. The composition of claim 8 wherein said (co) polyester (B) is PET.

11. The composition of claim 1 wherein said (co) polyester (B) is polybutylene terephthalate

12. A thermoplastic molding composition comprising
(A) 50 to 85% of a polycarbonate containing structural units derived from bisphenol A,
(B) 5 to 60% of PET, and
(C) 2 to 15% grafted rubber
said % being relative to the weight of the composition,
where said grafted rubber includes a substrate in an amount of 30 to 80 percent and a rigid grafted phase in an amount 70 to 20 percent, said percents relative to the weight of said grafted rubber, said substrate including
(C1) 1 to 50%, relative to the weight of the substrate of core containing the crosslinked polymerization product of at least one vinyl monomer and
(C2) 50 to 99% relative to the weight of the substrate of a shell enveloping said core, that contains at least one crosslinked, polymerized acrylate which has a glass transition temperature less than 0° C.,
said rigid grafted phase (C3) including a copolymer of at least one monomer selected from a first group consisting of styrene, α-methyl styrene, ring-halogenated styrene and ring-alkylated styrene, and at least one monomer selected from a second group consisting of (meth)acrylonitrile, methylmethacrylate and maleic anhydride, at a weight ratio between said monomer(s) of said first group to the monomer(s) of said second of 90:10 to about 50:50.

13. The composition of claim 1 wherein polycarbonate is polyestercarbonate.

14. The composition of claim 1 further containing at least one colorant.

15. The composition of claim 12 further containing at least one colorant.
